(19) United States
(12) Patent Application Publication
(10) Pub. No.: US 2008/0035001 A1
(43) Pub. Date: Feb. 14, 2008

(54) PLATE REPLACING APPARATUS

(75) Inventors: Minoru YOKOYAMA, Hiroshima (JP); Hiroyuki YANO, Hiroshima (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., Tokyo (JP)

(21) Appl. No.: 11/833,028

(22) Filed: Aug. 2, 2007

(30) Foreign Application Priority Data
Aug. 11, 2006 (JP) 2006-220298

(51) Int. Cl. B41F 27/12

(52) U.S. Cl. 101/477

(57) ABSTRACT

A plate replacing apparatus includes a plate-winding support roller that presses a plate on a plate cylinder and a plate pressing unit that rotates around the plate-winding support roller and thereby pressing a trailing end of the plate in an edge portion of the plate pressing unit. The plate pressing unit presses the plate in a position in front of a lower tooth of a vice built in the plate cylinder.

### BACKGROUND OF THE INVENTION

1. Field of the Invention

The present invention relates to a plate replacing apparatus included in a printing press, and more particularly, to a plate replacing apparatus that winds a plate around a plate cylinder.

2. Description of the Related Art

In a conventional plate replacing apparatus included in a printing press as disclosed in Japanese Patent No. 2956021, a new plate is pressed by a roller and wound around a plate cylinder.

To ensure the stiffness required for pressing the plate, the roller needs to have a diameter at least a predetermined length. Therefore, the roller interferes with a vice of the plate. In other words, the roller cannot firmly press a trailing end of the plate around the vice. As a result, the plate is not wound around the plate cylinder precisely. To solve the problem, a portion to be pressed by the roller is extended, or the vice is notched so that the roller can firmly press the plate to its trailing end. In a case in which the vice is notched, however, the stiffness may drop insufficiently.

### SUMMARY OF THE INVENTION

It is an object of the present invention to at least partially solve the problems in the conventional technology.

A plate replacing apparatus according to one aspect of the present invention includes a plate-winding support roller that presses a plate on a plate cylinder and a plate pressing unit that rotates around the plate-winding support roller and thereby pressing a trailing end of the plate in an edge portion of the plate pressing unit. The plate pressing unit presses the plate in a position in front of a lower tooth of a vice built in the plate cylinder.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a printing press according to an embodiment of the present invention, including a plate replacing apparatus;

FIG. 2 is a schematic diagram of a protective cover of the printing press shown in FIG. 1;

FIG. 3 is a schematic diagram of the protective cover shown in FIG. 2 when an upper portion of the protective cover rotates;

FIG. 4 is a side view of a plate cylinder and a plate-winding support roller;

FIG. 5 is a side view of the plate replacing apparatus;

FIG. 6 is a side view of the plate replacing apparatus for explaining a movement of a link mechanism;

FIG. 7 is a side view of a plate pressing unit contained inside the protective cover;

FIG. 8 is an enlarged view of the plate pressing unit;

FIG. 9 is a front view of the plate replacing apparatus in a state shown in FIG. 8;

FIG. 10 is a schematic diagram for explaining a movement of the link mechanism; and

FIG. 11 is a schematic diagram for explaining how arms are folded and the plate pressing unit moves.

### DETAILED DESCRIPTION OF THE PREFERRED EMBODIMENTS

Embodiments of the present invention are explained in detail below with reference to the accompanying drawings. The present invention is not limited to the embodiments. Incidentally, components capable of being easily conceived by those skilled in the art are to be employed in the embodiments.

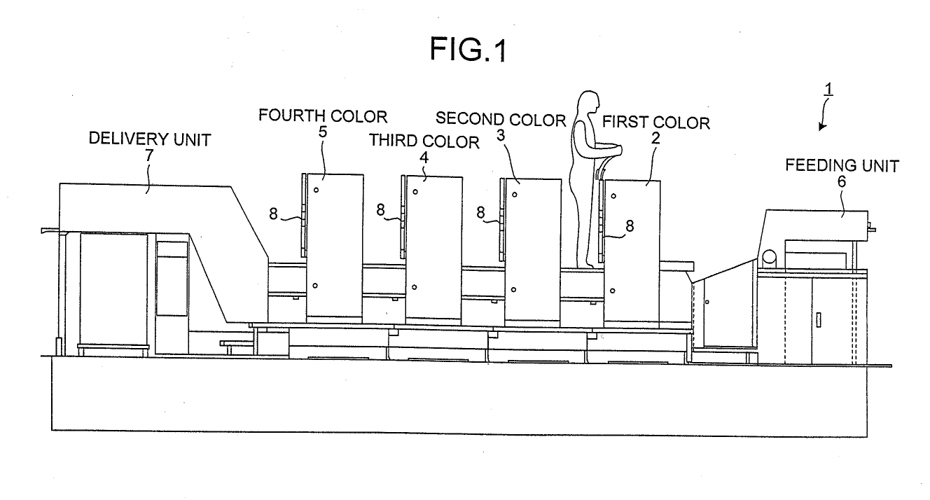

FIG. 1 is a side view of a printing press 1 according to an embodiment of the present invention, including a plate replacing apparatus. The printing press 1 includes a feeding unit 6, printing units 2, 3, 4, and 5, and a delivery unit 7. The feeding unit 6 feeds paper to be printed thereon to the printing unit. The printing units 2, 3, 4, and 5 respectively print an image in different colors, such as in cyan, magenta, yellow, and black, on the paper fed from the feeding unit 6 by overlapping each color sequentially. The printed paper is output by the delivery unit 7. Each of the printing units 2, 3, 4, and 5 respectively includes a number of rollers, such as a plate cylinder and an impression cylinder, those required for printing. These rollers are covered by a protective cover 8.

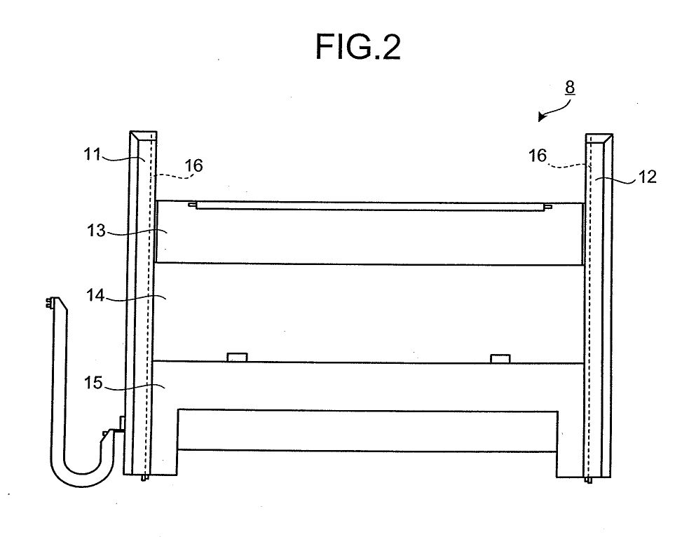

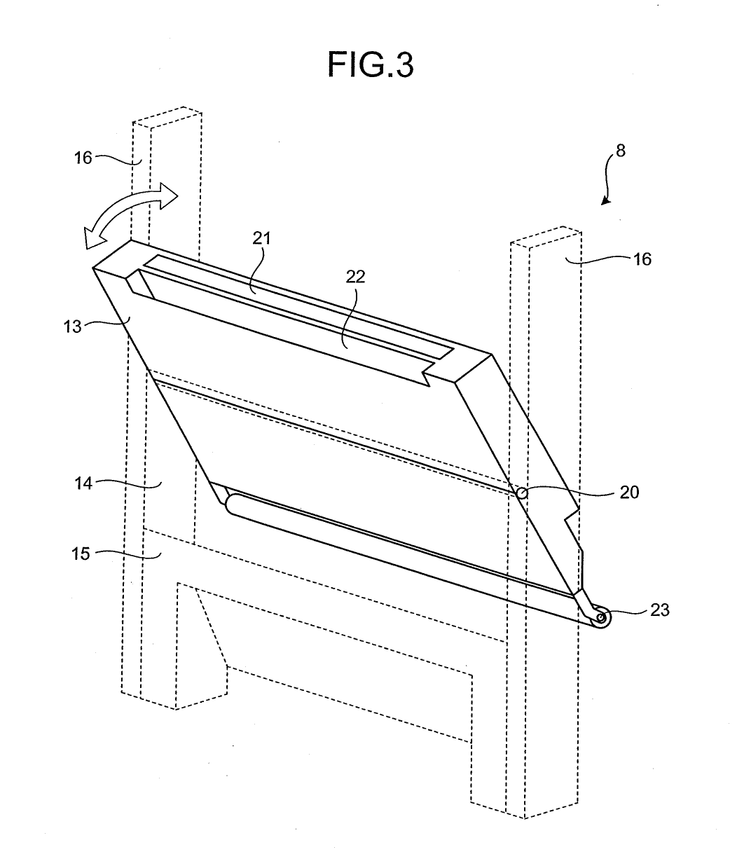

FIG. 2 is a schematic diagram of the protective cover 8. The protective cover 8 is separated into an upper portion 13, a middle portion 14, and a lower portion 15. Both ends of the portions 13 to 15 are coupled to rectangular column-shaped frames 16 that are building frames of each of the printing units 2 to 5 (see FIG. 3). The frames 16 are covered by covers 11 and 12 respectively.

FIG. 3 is a schematic diagram of the protective cover 8 when the upper portion 13 rotates. The upper portion 13 serves as the plate replacing apparatus. As shown in FIG. 3, an old-plate removing slot 21 and a new-plate inserting slot 22 are provided on top of the upper portion 13.

The upper portion 13 is configured to rotate around a rotation shaft 20 and slant at a predetermined angle with respect to the middle portion 14 and the lower portion 15. A plate-winding support roller 23 is provided at the end of the upper portion 13. The plate-winding support roller 23 presses a new plate on a plate cylinder (not shown), and supports the new plate to be wound around the plate cylinder. Except when a plate is to be replaced, the upper portion 13 serves as an upper structure of the protective cover 8.

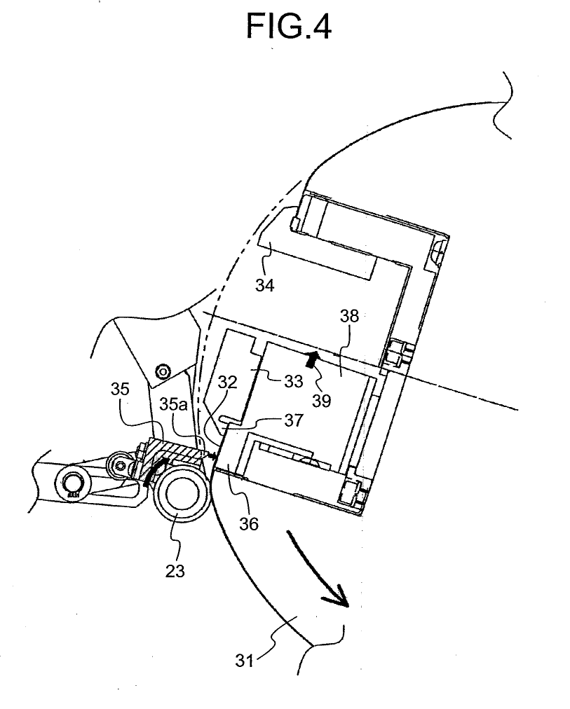

FIG. 4 is an enlarged side view of a plate cylinder 31 and the plate-winding support roller 23. A plate 32, which is gripped by a gripper-end side vice 34 built in the plate cylinder 31, is pressed on the plate cylinder 31 by the plate-winding support roller 23. Incidentally, a width of the plate-winding support roller 23 is approximately the same as that of the plate cylinder 31. The plate 32 rotates around the plate cylinder 31 by being pressed by the plate-winding support roller 23, and eventually is held by a trailing-end side vice 33 built in the plate cylinder 31.

A plate pressing unit 35 is provided on the plate-winding support roller 23. The plate pressing unit 35 rotates around the plate-winding support roller 23 across the full width of the plate-winding support roller 23, and an end portion 35a of the plate pressing unit 35 presses a trailing end of the plate. Specifically, the end portion 35a of the plate pressing unit 35 presses the plate 32 that is located in front of a lower tooth 36 of the vice 33 until the trailing-end side vice 33 grips the plate 32. Incidentally, to prevent a deflection or a displacement of the plate 32 as much as possible, it is preferable that a main body 38 of the trailing-end side vice 33 is configured to move linearly in a direction of an arrow 39 to pull the plate 32 by holding the plate 32.

If it is assumed that the plate pressing unit 35 is not provided on the plate-winding support roller 23, the plate 32 can be pressed by the plate-winding support roller 23, but it is not possible to firmly press a portion of the plate 32 which is close to the trailing-end side vice 33 because the plate-winding support roller 23 has a predetermined length of a diameter. Consequently, the plate 32 cannot be wound around the plate cylinder 31 precisely. If a portion close to the trailing-end side vice 33 is extended to solve the problem, a space for a picture image in the plate 32 is reduced.

According to the embodiment, the plate pressing unit 35 is provided on the plate-winding support roller 23, and thus it is possible to firmly press the portion of the plate 32 which is geometrically close to a holding unit 37 of the trailing-end side vice 33. Therefore, the plate-winding precision can be maintained, and also a longitudinal length of the picture image can be maximized. Furthermore, the plate 32 is pressed in accordance with the rotation of the plate pressing unit 35, so that even if a plate has a high stiffness and is not sufficiently pressed by the plate-winding support roller 23, the plate can be pressed on the lower tooth 36 of the trailing-end side vice 33 without any force. Incidentally, the plate pressing unit 35 needs not have an L-shape as shown in the drawing. The plate pressing unit 35 can have any shape as long as the end portion of the plate pressing unit 35 can press the plate in accordance with the rotation of the plate pressing unit 35.

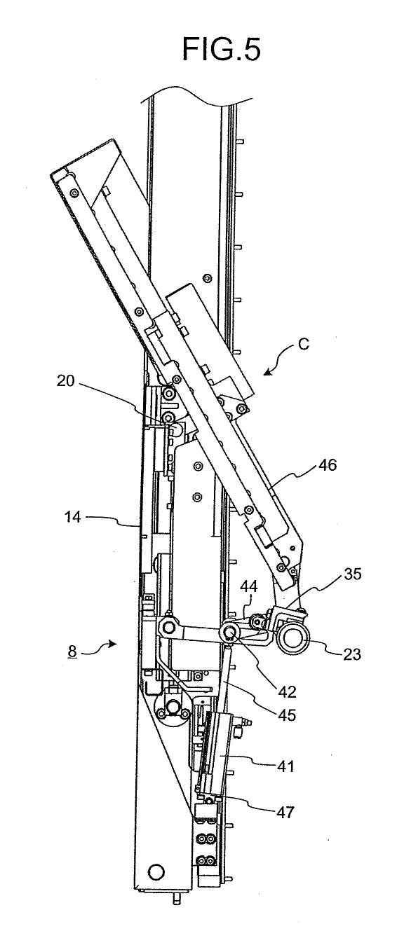

FIG. 5 is a side view of a plate replacing apparatus C. As described above, when a plate is to be replaced, the plate replacing apparatus C, which is the upper portion 13 of the protective cover 8, rotates so that an outlet of a new-plate insertion path and an inlet of an old-plate removal path 46 move close to the plate cylinder 31. The plate-winding support roller 23 and the plate pressing unit 35 capable of rotating around the plate-winding support roller 23 are arranged at the end of the plate replacing apparatus C. The plate pressing unit 35 is controlled rotating and pressing around the plate-winding support roller 23 by a link mechanism L that is coupled to an air cylinder 41 as a translatory actuator.

As shown in FIG. 5, when a rod 45 of the air cylinder 41 is extended, a joint (the second joint) between arms 43 and 44 composing of the two-joint link mechanism L is pushed up. The plate pressing unit 35 coupled to the arm 44 is constrained to move on an orbit centering around a shaft of the plate-winding support roller 23. Therefore, when pushed up by the arm 44, the joint is pressed towards the lower tooth 36 of the trailing-end side vice 33 (see FIG. 4).

The main-body side of an end portion 47 of the air cylinder 41 is arranged inside the protective cover 8. When the link mechanism L is folded, the air cylinder 41 is contained inside the protective cover 8 together with the plate-winding support roller 23 and the plate pressing unit 35. For example, by enabling the protective cover 8 to open/close up and down, at the time of maintenance of the printing units, the plate pressing unit 35 and the plate-winding support roller 23 do not interfere with rollers, such as the plate cylinder and a blanket cylinder, inside printing units.

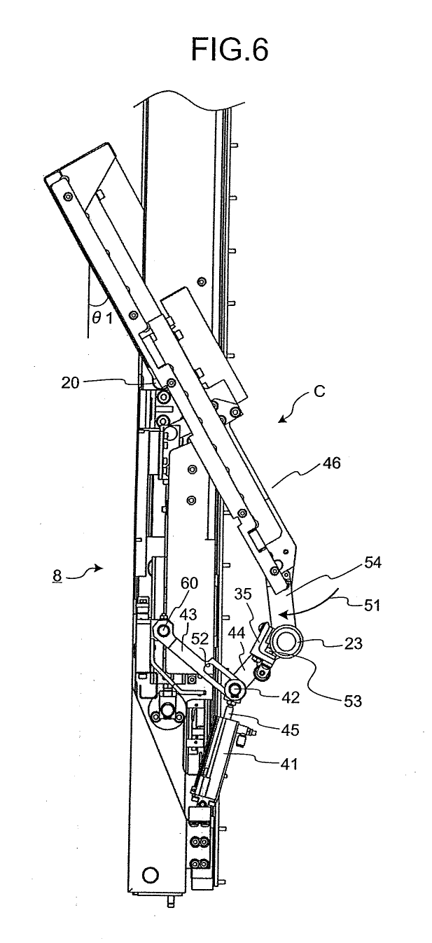

FIGS. 6 to 8 are side views for explaining a movement of the link mechanism. As shown in FIG. 6, when a new plate is inserted, the plate replacing apparatus C rotates at an angle θ1 with respect to the protective cover 8. At this time, the plate-winding support roller 23, which is biased in a direction towards the plate cylinder by a spring or the like, rotates in a direction of an arrow 51, which is an opposite direction against the bias, because of a reaction of pressing on the plate cylinder. As the rod 45 of the air cylinder 41 is contracted, a second joint 42 between the arms 43 and 44 comes down, and the arms 43 and 44 those in a state as shown in FIG. 5 are folded. Then, as the second joint 42 comes down, the plate pressing unit 35 rotates counterclockwise, and locates a position where the plate pressing unit 35 contacts neither the old plate nor the new plate regardless of an angle of the plate replacing apparatus C. Therefore, the plates can be prevented from being scratched by the plate pressing unit 35.

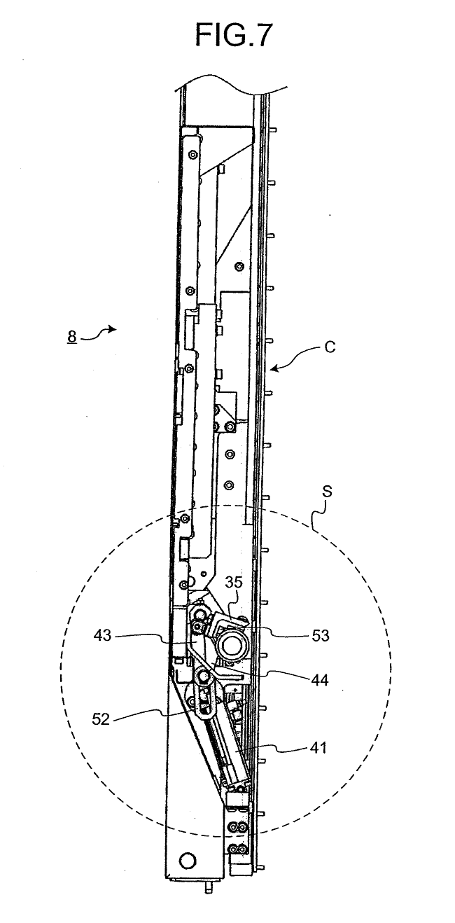

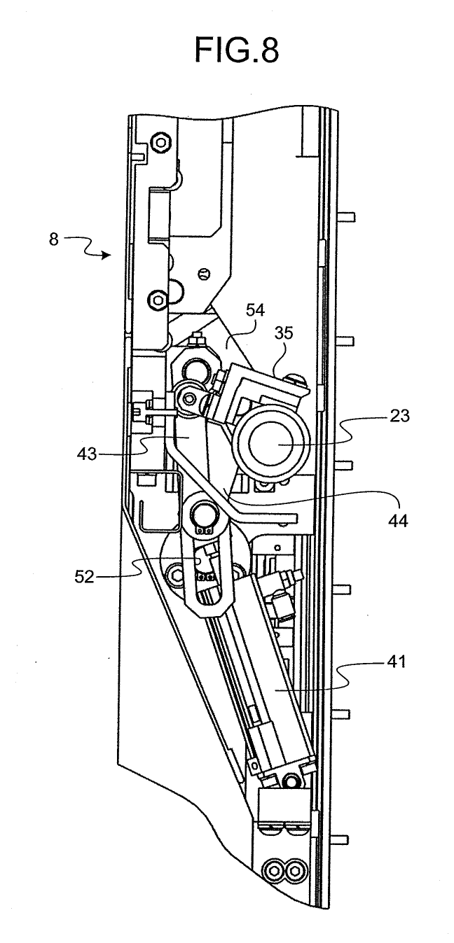

FIG. 7 is a side view of the plate replacing apparatus C when the plate pressing unit 35 is contained inside the protective cover 8. FIG. 8 is an enlarged view of a region S shown in FIG. 7. As shown in FIGS. 7 and 8, when the plate replacing apparatus C rotates and is contained inside the protective cover 8 by contracting the rod 45 of the air cylinder 41, the arm 44 guided by the plate pressing unit 35, which is rotatably provided on the shaft of the plate-winding support roller 23, is folded by sliding a slide hole 52 of the arm 43. At this time, the arms 43 and 44 are partially overlapped with each other.

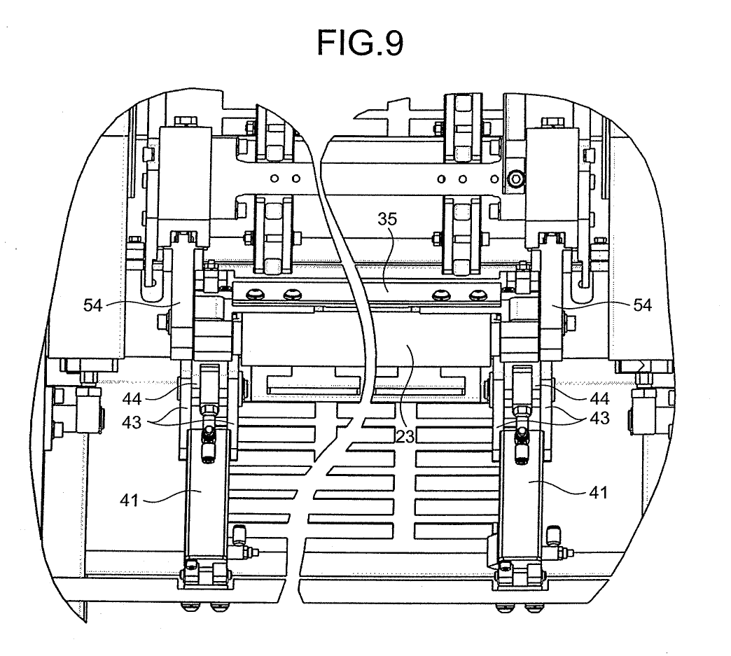

FIG. 9 is a front view of the plate replacing apparatus C in a state shown in FIG. 8. As shown in FIG. 9, the plate replacing apparatus C contained inside the protective cover 8 stores therein a new plate that is inserted in advance until the new plate is wound around the plate cylinder. Therefore, it is necessary to secure as much space as possible in a thickness direction of the plate replacing apparatus C so that the new plate can be inserted and stored therein.

According to the embodiment, when the plate pressing unit 35 is contained inside the protective cover 8, the plate pressing unit 35 is configured to rotate in the same direction as that the plate is pressed by the link mechanism L (in a case shown in FIG. 8, in a clockwise direction), and to stop rotating at a certain rotational position (at a position shown in FIG. 8) where the plate pressing unit 35 does not contact any other members inside the protective cover 8. The rotation of the plate pressing unit 35 is controlled by the link mechanism L.

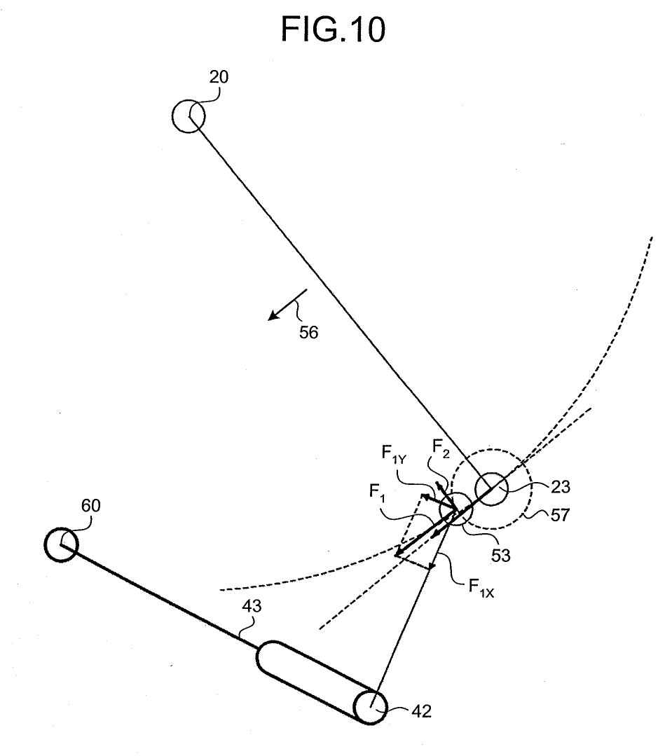

FIG. 10 is a diagram for explaining a movement of the link mechanism. As shown in FIG. 10, the rotation shaft 20 of the protective cover 8 in a state shown in FIG. 6 is coupled to the plate-winding support roller 23. The plate-winding support roller 23 is further coupled to the plate pressing unit 35. The plate pressing unit 35 is further coupled to the second joint 42 between the arms 43 and 44. The link mechanism L in which the rod 45 of the air cylinder 41 is contracted acts in accordance with the rotation of the plate replacing apparatus C.

When the plate-winding support roller 23 rotates in a direction of an arrow 56, a force F1 applied to the plate-winding support roller 23 is transmitted to a shaft 53 of the plate pressing unit 35 that is rotatably provided on the plate-winding support roller 23. The force F1 can be considered as a resultant of a force F1X in a direction along the arm 44 (hereinafter, an “X direction”) and a force F1Y in a direction perpendicular to the X direction (hereinafter, a “Y direction”). When the force F1Y as a component force of the resultant is applied to the shaft 53 of the plate pressing unit 35, the shaft 53 receives a force F2 in a direction to rotate clockwise because the shaft 53 is constrained by an orbit 57 of the plate-winding support roller 23.

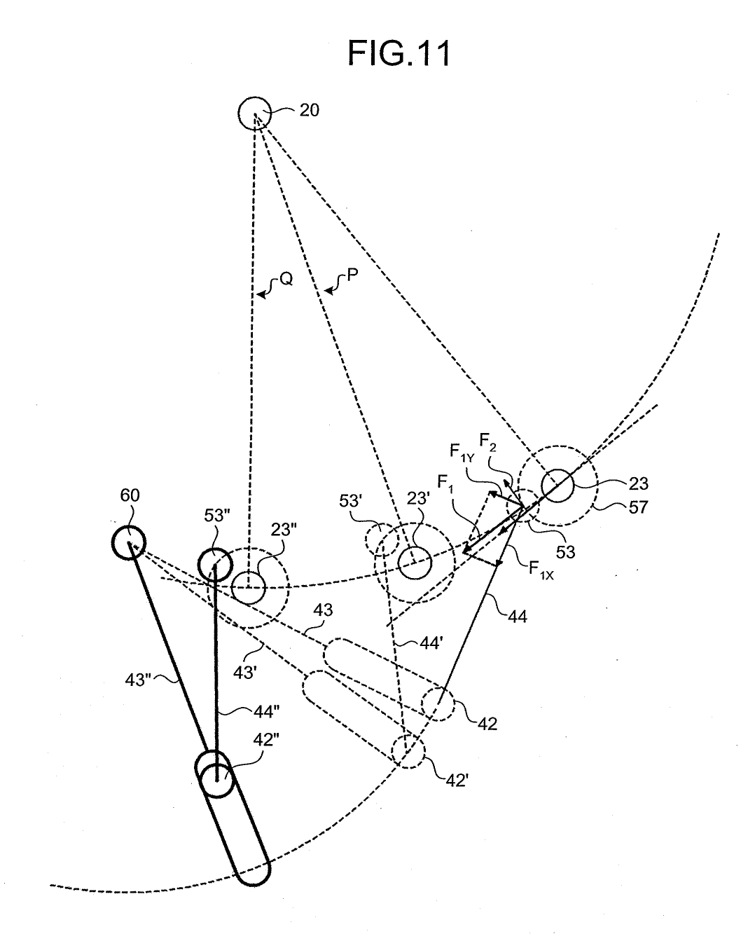

FIG. 11 is a schematic diagram for explaining how arms are folded and the plate pressing unit moves. At a position P, a shaft 53′ of the plate pressing unit 35 is located at a position where the plate pressing unit 35 further rotates clockwise from a position shown in FIG. 6 or 10. At a position Q, the plate pressing unit 35 further rotates clockwise from the position P. When the plate replacing apparatus C is at the position Q, a shaft 53″ of the plate pressing unit 35 is located above the plate-winding support roller 23 (in a case shown in FIG. 11, in a direction of 10 o'clock). At this time, the plate pressing unit 35 is in a state shown in FIG. 7 or 8. Incidentally, the second joint 42 between the arms 43 and 44 slides in the hole 52 of the arm 43, and moves from a position 42′ to a position 42″. In the event, the arm 44 is folded until the arms 43 and 44 are partially overlapped with each other (as indicated by arms 43″ and 44″).

In the above embodiment, when contained inside the protective cover 8, the plate pressing unit 35 rotates clockwise, but if space allows, there is no need to be limited to rotate clockwise specifically. The plate pressing unit 35 can be arranged as desired by changing lengths of the arms 43 and 44 and a position of the shaft 53 of the plate pressing unit 35 appropriately.

According to an aspect of the present invention, the plate pressing unit can press close to a trailing end of a plate. Thus, a longitudinal length of a picture image can be maximized close to a trailing end of the plate.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A plate replacing apparatus comprising:
a plate-winding support roller that presses a plate on a plate cylinder; and
a plate pressing unit that rotates around the plate-winding support roller and thereby pressing a trailing end of the plate in an edge portion of the plate pressing unit, wherein
the plate pressing unit presses the plate in a position in front of a lower tooth of a vice built in the plate cylinder.

2. The plate replacing apparatus according to claim 1, wherein rotating of the plate pressing unit around the plate-winding support roller and pressing of the plate pressing unit on the plate are controlled by a link mechanism to which a translatory actuator is coupled.

3. The plate replacing apparatus according to claim 2, wherein
the link mechanism applies a two-joint link mechanism to the plate pressing unit that rotates around a shaft of the plate-winding support roller, and
a main body side of an end portion of the translatory actuator, which is coupled to a second joint of the link mechanism, is arranged inside a protective cover.

4. The plate replacing apparatus according to claim 2, wherein
when not replacing the plate, the link mechanism is folded, and the plate pressing unit is contained inside a protective cover of a main body of the apparatus together with the plate-winding support roller, and
when the plate pressing unit is contained inside the protective cover, the plate pressing unit rotates in a same direction as a direction when the plate is pressed by an action of the link mechanism, and stops rotating at a rotational position where the plate pressing unit does not contact other members inside the protective cover.

5. The plate replacing apparatus according to claim 1, wherein the plate replacing apparatus is built in a protective cover, rotates and moves close to the plate cylinder when a plate is to be replaced, and includes the plate-winding support roller and the plate pressing unit in its distal end.
